(19) United States
(12) Patent Application Publication
(10) Pub. No.: US 2020/0261872 A1
(43) Pub. Date: Aug. 20, 2020

(54) METHOD FOR THE TRIBOELECTRIC CHARGING OF CHEMICALLY CONDITIONED BULK SALT MIXTURES

(71) Applicant: K+S Aktiengesellschaft, Kassel (DE)

(72) Inventors: Roland Scharfenberg, Heringen-Woelfershausen (DE); Heiko Nuhn, Hohenroda Ransbach (DE); Uwe Wachsmuth, Bad Sooden-Allendorf (DE); Ludger Waldmann, Telgte (DE)

(73) Assignee: K+S Aktiengesellschaft, Kassel (DE)

(21) Appl. No.: 16/649,734

(22) PCT Filed: Oct. 11, 2018
(86) PCT No.: PCT/DE2018/000289

§ 371 Date: Mar. 23, 2020

(30) Foreign Application Priority Data
Oct. 12, 2017 (DE) 10 2017 218 206.7

(51) Int. Cl. B01F 7/24; B01F 5/10; B01F 7/00; B03C 7/00

(52) U.S. Cl. CPC B01F 7/243; B01F 5/10; B01F 2215/0036; B03C 7/006; B01F 7/00541

(57) ABSTRACT

A method is useful for triboelectrically charging chemically conditioned bulk salt mixtures by mechanically moving the bulk salt mixture in a container by at least one vertical mixer.

The invention relates to a method for the triboelectric charging of chemically conditioned salt mixtures, a method for the electrostatic separation of salt mixtures, in particular crude potassium salts, and the use of vertical mixers in these methods, and also an apparatus for the triboelectric charging of chemically conditioned salt mixtures.

The separation of crude salts from potash mines is known. For example, G. Fricke, Kali und Steinsalz, Number 9/1986, pages 287 to 295, describes purification of the mineral kieserite from crude salts by means of the dry electrostatic separation method. For this purpose, crude salt is milled, classified to a predetermined particle size, provided with a small amount of conditioning agent, which is usually an organic compound, and fluidized with air having a particular temperature and humidity and triboelectrically charged. The mixture is separated in an electrostatic field into a desired material fraction and a residue fraction, for example into a crude kieserite fraction and a crude potassium fraction.

As described in EP-A-0231441, DE 26 43 002 C2, EP-B-1 884 287 in paragraph [0014] and DE 39 21 073 C2, contacting of the crude potassium salt to be separated can be carried out in a known manner in a fluidized bed in which the salt mixture is triboelectrically charged.

The separation of the crude potassium salt, for example into a crude kieserite fraction and a crude potassium fraction, is typically carried out in an electrostatic separator, preferably in a free-fall separator.

To effect triboelectric charging of a salt mixture which has been specifically chemically conditioned, the salt mixture has to be contacted in order for it subsequently to be able to be separated into its components in an electric field.

In general, different charging mechanisms come into consideration. A distinction is made between particle-particle and particle-wall contacts. There are theoretical models of the phenomenon of triboelectric charging. In the model of Ernst, various materials strive to attain a thermodynamic equilibrium state, which brings about a transition of electrons at the interfaces. Adsorbed water molecules and lattice defects at the surfaces are, according to Ernst, the cause of relevant surface states. Chemical conditioning to form effective conditioning agent-water adsorbate complexes produces substrate-specific energy states.

In the model of Pfnür, the assumptions of Ernst are taken up and expanded by the energy band model of quantum mechanics. According to Pfnür, adsorbed conditioning agent orbitals interact with the crystal lattice at clean surfaces. In the model of Pfnür, new energy levels between the valence band and conduction band arise as a result of the chemical conditioning, leading to the effective band gap being minimized. On excitation, electrons travel through these new energy levels from one mineral phase to the other.

The use of, inter alia, static mixers made of copper for triboelectric charging in the coal, quartz and pyrite system (see Hangsubcharoen, M., A Study of Triboelectrification Mechanisms for Coal, Quartz and Pyrite, Virginia Polytechnic Institute and State University, Blacksburg, Va., thesis 1999), rotors in chambers (see U.S. Pat. No. 8,338,734 B2) and stirring devices in vessels and horizontal mixers for the triboelectric charging of polymer particles has hitherto been known from the prior art. As regards the two latter uses, reference may be made, for example, to DE-B4-101 40 241 and JP-A-2000061356. A pointer to the triboelectric charging of chemically conditioned salt mixtures, preferably in the dust size range, is not to be found in these documents.

Fluidized-bed apparatuses as are described, for example, in EP-A-0231441, which utilize a contacting fluidized bed of the salt particles and in which particle-particle contacts predominate, are especially suitable for the triboelectric charging of chemically conditioned salt particles in the particle size range from 0.1 to about 3 mm. Fluidized beds have been found to be useful as contacting unit in large-scale continuous processes since they simultaneously fulfil further important functions apart from contacting. Thus, any undesirable very fine particles (particle size <0.1 mm) which occur and would be able to be separated into their constituents only with difficulty in the electric field of a free-fall tubular separator can be removed by suction with the aid of upstream fluidized beds before the separation in the electric field. Furthermore, the salt temperature which is important for the electrostatic separation of salt mixtures and the relative atmospheric humidity associated therewith can be set with the aid of fluidized beds by heating of the inflowing air.

The patent document DE 26 14 146 C2 comprehensively discusses the disadvantages of the use of a fluidized bed and proposes a solution involving the use of downflow apparatuses.

However, if a predominantly or exclusively dust-like, chemically conditioned salt mixture in the particle size range up to a maximum of 0.1 mm is to be triboelectrically charged for subsequent separation in an electric field, the use of a fluidized bed as contacting unit is all the more problematical, since a large proportion of the salt dust may be discharged in the exhaust air and not, as desired, conveyed further into the electric field of a separation apparatus. This would lead to large circulating amounts, which impairs the economics of this method. In addition, fluidized-bed apparatuses require a great deal of space due to the necessity of dedusting plants, as a result of which the fixed and variable costs for the use of a fluidized bed can be high.

The downflow apparatuses mentioned in the patent document DE 26 14 146 C2 cannot be used for a predominantly or exclusively dust-like, chemically conditioned salt mixture having a particle size range up to a maximum of 0.1 mm since the material is so fine that downflow cannot be ensured to a sufficient extent. Severe caking and severe aerosol formation occurs here, so that a controlled flow of material cannot be realized.

To address this problem, for example, Oberrauner (“Nutzung der Elektroscheidung zur trockenen Aufbereitung von fein-und feinstdispersen Körnerschwärmen” in preparation in Österreich III, Decade Report 2005 to 2015, pages 83 to 85) has described a specific drum-shaped rotor-stator charging unit which is connected to a pneumatic transport unit. However, disadvantages here are the small throughput and the very long residence time of 6 hours necessary for triboelectric charging.

A good and up-to-date overview of the various customary charging and separation apparatuses including a comprehensive literature and patent directory is given by the article “Electrostatic Separation” in Ullmann's Encyclopedia of Industrial Chemistry (Online ISBN: 9783527306732). Many of the patents cited and the literature do not disclose details as to how triboelectric charging is effected, but instead state: “triboelectrically charged by vigorous movement” or “by mixing” without giving a more precise description of the mixing operation, although it is known to an expert that the manner of contacting for triboelectric charging and also the external conditions such as temperature and relative humidity also have an influence on the quality of the charging operation.

It is an object of the present invention to provide a method for the triboelectric charging of chemically conditioned salt mixtures by mechanical movement of the salt mixture, which also makes it possible to charge salt mixtures in a particle size range up to a maximum of 0.25 mm, in particular a maximum of 0.1 mm.

The object is achieved according to the invention by a method for the triboelectric charging of chemically conditioned salt mixtures by mechanical movement of the salt mixture, characterized in that the mechanical movement of the salt mixture is carried out in a vessel by means of at least one vertical mixer.

The object is additionally achieved according to the invention by a method for the electrostatic separation of salt mixtures, in particular crude potassium salts, by contacting of the salt mixture with a chemical conditioning agent, subsequent triboelectrical charging of the chemically conditioned salt mixture by a method as described above and subsequent electrostatic separation of the triboelectrically charged salt mixture.

The object is additionally achieved by use of vertical mixers as are described above for the triboelectric charging of salt mixtures, in particular crude potassium salts.

The object is additionally achieved by an apparatus for the triboelectric charging of chemically conditioned salt mixtures by mechanical movement of the salt mixture, which has a vessel having at least one vertical mixer arranged therein and preferably also an apparatus for fluidizing the salt mixture and/or an apparatus for heating the salt mixture in or on the vessel, as are described above.

The present invention provides for the use of a vertical mixer rather than the disadvantageous fluidized bed described above as contacting unit for the triboelectric charging of, in particular, dust-like, chemically conditioned salt mixtures for subsequent separation into their components in an electric field in a suitable separation apparatus.

Vertical mixers known to those skilled in the art are used for mixing and homogenizing bulk materials in silos. The mixing process brought about by the vertical mixer in the salt bed of the silo is utilized according to the invention for the triboelectric charging of the in particular dust-like, chemically conditioned salt mixture.

In contrast, it was not possible to obtain sufficient triboelectric charging of the in particular dust-like, chemically conditioned salt mixture using horizontally arranged screws and single-shaft flow mixers (see comparative examples 4 and 5 below).

The method of the invention can be used for the triboelectric charging of any chemically conditioned salt mixture. Here, the salt mixture typically has a particle diameter of not more than 1 mm. The method of the invention is preferably used for the triboelectric charging of, in particular, chemically conditioned salt mixtures which have a particle diameter of preferably not more than 0.5 mm, particularly preferably not more than 0.25 mm, in particular not more than 0.1 mm.

At a maximum particle diameter of 0.1 mm in particular, it is also possible to speak of a dust-like salt mixture. The particle size can be determined by laser light scattering or optical analysis of the particles, for example by means of a Camsizer which produces images of the salt mixture by means of a digital camera and evaluates these in respect of the particle diameter. It is also possible to sieve or classify the salt mixture, with the corresponding sieve fraction indicating the maximum particle size.

For dust-like, chemically conditioned salt mixtures in particular, there has hitherto been no method for triboelectric charging. This triboelectric charging is achieved by the movement according to the invention of the salt mixture in a vessel by means of at least one vertical mixer, without the small particle size in the salt mixture leading to problems.

The at least one vertical mixer used according to the invention produces a vertically directed mass flow of the salt mixture and thus transports the salt mixture in the vertical direction in a vessel. A vertical mixer thus combines mixing with a vertically directed mass flow of the salt mixture.

Since the salt mixture leaves the vertical mixer at a position different from that at which it has entered, mixing of the salt mixture and triboelectric charging associated therewith are achieved. Compared to horizontal mixers, screws and similar apparatuses, the salt mixture in the vertical mixer is conveyed not only in the direction of the outlet but the vertically arranged transport device transports it in a direction opposite to the outflow direction, so that a type of circular flow of material arises and friction of the salt particles with one another is ensured, assisting triboelectric charging.

The outflow direction is the direction which runs from the input position of the salt mixture to the outflow position in the vessel.

The vertical mixer preferably has a vertically arranged mixing screw which conveys the salt mixture vertically upward from the bottom of the vessel. The expression “from the bottom of the vessel” means the region above the bottom of the vessel (outlet) from which the salt mixture is taken off. It will be clear to a person skilled in the art that the salt mixture should be taken up as close as possible to the bottom of the vessel and be conveyed vertically upward to obtain particularly good mixing. However, commencement of the vertically arranged mixing screw at a distance above the bottom of the vessel is also possible according to the invention.

Taking-off or discharging of the salt mixture from the vessel is preferably carried out at the (lower) bottom of the vessel.

The introduction or feeding of the salt mixture into the vessel is preferably effected at the top of the vessel or at the vessel lid which is opposite the bottom of the vessel.

The transport screw is preferably arranged entirely or at least partly, preferably predominantly, in a mixing tube, so that the salt mixture is conveyed vertically upward in the mixing tube. Here, the mixing tube has one or more lateral openings along its course, through which openings the salt mixture exits laterally from the mixing tube. The mixing tube is preferably closed at the top, so that exit occurs only through the one or more lateral openings. Preference is given to two or more lateral openings being provided. Individual lateral openings can be oriented in different horizontal directions.

Furthermore, preference is given to at least one of the lateral openings being arranged within a mixing head by means of which the direction of movement of the salt mixture outside the mixing tube is changed or diverted in a vertically downward direction.

Preference is given to at least one lateral opening being arranged in the upper region of the vessel, in the case of a vessel closed at the top in the vicinity of this vessel lid. At least one further lateral opening is arranged along the course of the transport screw and is arranged within a mixing head. Particular preference is given to all lateral openings with the exception of the openings arranged at the upper end of the mixing tube being arranged within mixing heads.

The mixing head is particularly preferably configured as sleeve having the shape of a frustum of a cone, which surrounds the mixing tube and at the top rests against the mixing tube and is open in a downward direction, so that the salt mixture exits vertically in a downward direction from the mixing head outside the mixing tube.

Other embodiments of a mixing head are also possible according to the invention, as long as they lead to a reversal in the direction of movement of the salt mixture from vertically upward to vertically downward.

The triboelectric charging is achieved by contact of the particles in the salt mixture with one another and with the walls and internals of the vessel and of the vertical mixer.

The vessel preferably has the shape of a silo with sidewalls which taper conically toward the bottom in at least the lower fifth, preferably in at least the lower third, of the silo tubes. The silo particularly preferably has a circular cross section in the center of which a vertical mixer is arranged.

The edges of the silo can be rounded, corresponding to the typical shape of silos.

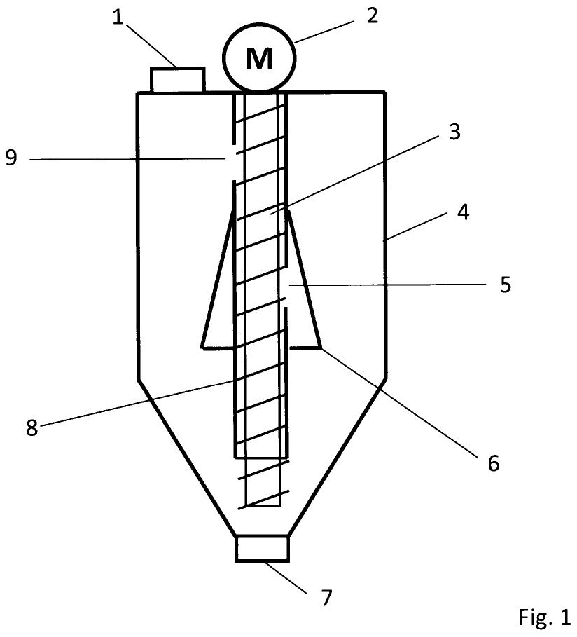

FIG. 1 shows a schematic cross-sectional view of such a silo which has a vertical mixer according to the invention with vertically arranged mixing screw along its vertical central axis.

Here, the reference numerals have the following meanings:
1 introduction of the salt mixture into the silo from above
2 drive of the vertically arranged mixing screw
3 vertically arranged mixing screw (transport from the bottom upward)
4 exterior skin of silo
5 lateral opening (cut-out) in the mixing tube, arranged within a mixing head
6 mixing head
7 outlet for the salt mixture to the electrostatic separation apparatus
8 mixing tube
9 lateral opening (cut-out) in the mixing tube

As shown in FIG. 1, the transport screw projects beyond the mixing tube in the lower region. A reversal of the direction of movement of the salt mixture conveyed from the bottom upward is achieved by means of the conical mixing head 6 which is open in the downward direction. The opening 9 in the vicinity of the upper wall of the silo does not have a mixing head since the reversal of the direction of movement is achieved by the silo walls.

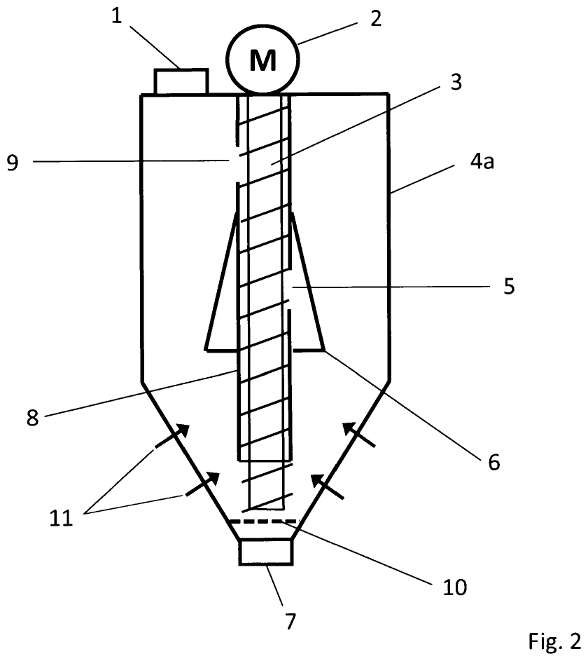

FIG. 2 shows a schematic cross-sectional view of a silo which is preferred according to the invention and has a fluidizing internal ring and compressed air cushions (flow pads) right around the cone in addition to the vertical mixer. Furthermore, the vessel wall is thermally insulated and has supplementary electric heating.

The additional reference numerals have the following meanings:
4a silo with thermally insulated vessel wall and supplementary electric heating
10 fluidizing internal ring
11 compressed air cushions (flow pads) arranged right around the cone

Fluidization is achieved at the bottom of the silo by means of the fluidizing internal ring 10, which is a compressed air-driven, vibrating polymer membrane in the cone region which is air-permeable. As a result of the additional compressed air cushions or compressed air lances (flow pads) in the cone region of the silo or in the sidewalls which taper conically toward the bottom, fluidization is achieved in the lower region of the silo which runs toward the intake region of the mixing screw. The additional fluidization brings about increased particle-particle contact, so that the triboelectric charging is improved (see example 3).

The thermally insulated vessel wall and supplementary electric heating make it possible to set a temperature necessary for triboelectric charging in the salt mixture in the silo. The supplementary electric heating, the compressed air-operated fluidizing internal ring and the flow pads make it possible to set the relative atmospheric humidity in the silo and thus in the salt mixture so that triboelectric charging is possible.

A combination of vertical mixer, fluidizing internal ring, compressed air cushions (flow pads) and thermal insulated vessel wall with supplementary electric heating is particularly preferably present in the silo.

As a result, the mechanical prerequisites for triboelectric charging are created and the temperature and atmospheric humidity prerequisites are also met.

The construction of the vertical mixers used according to the invention is based on the principle of producing a plurality of mass streams in the mixing vessel.

The vessel (silo) can here be used in batch operation or in continuous operation.

A preferred embodiment of the method of the invention and the apparatus of the invention will be described below.

The dust-like salt mixture to be mixed is firstly conveyed vertically upward by a free-standing mixing screw installed in the central mixing tube. The mixing tube is provided with one or more mixing heads. At the one or more mixing heads, the salt mixture is partly discharged into the downward-directed particle stream. The remaining amount of the salt mixture is discharged from the mixing tube at the upper end. This system in combination with the angle of the mixing heads and the vessel cone produces mixing zones with high friction in the salt bed which is kept in motion and is thus an extremely effective mixer which brings about particularly intensive triboelectric charging of the dust-like salt mixture by ensuring a large number of particle-particle contacts.

The mixing system of the vertical mixer can, as shown above in FIG. 2, be additionally supplemented by an apparatus for fluidizing the salt mixture, preferably a pneumatically operated fluidization plate, e.g. by a vibrating membrane in the silo cone. The additional use of such fluidization, preferably in combination with compressed air cushions (flow pads) at the sidewalls, can increase the triboelectric charging of the dust-like salt mixture and thus improve the separation result in the separation into its components in an electric field.

### Flow Pads

Flow pads are preferably conical air lances on the silo cone which are operated by means of compressed air, e.g. about 5 bar, and bring about pulse-like air bumps at the silo interior wall, so that any salt bridges in the silo (very fine salt dust in particular can form salt bridges in the silo, and salt bridges prevent flow) collapse and thus allow flow of the salt through to the mixing screw which then conveys vertically upward. This leads to the desired mixing effect of the vertical mixer, which without flow pads might be hindered as a result of formation of salt bridges.

### Fluidizing Internal Ring

This is a vibrating polymer membrane operated by means of compressed air, e.g. about 2-3 bar compressed air, in the lower part of the silo cone which by producing finely dispersed air bubbles (as in a whirlpool) in the mechanically moved salt dust bed brings about additional pneumatic fluidization of the salt dust.

It can be necessary for particular separation tasks for the preferably dust-like salt mixture to be heated during contacting in the vertical mixer silo. For this purpose, a device for heating the salt mixture can be arranged in or on the vessel, e.g. supplementary electric heating with insulation can additionally be installed on the outer wall of the silo. Heat exchange between the outer wall and the salt mixture in the silo can occur readily due to the circulation at a suitable residence time in the vessel.

In industrial-scale production facilities for the electrostatic treatment of dust-like salt mixtures, continuously operated stock silos are generally necessary in order to ensure equalized discharge flow of the salt mixture to the separation apparatuses. The important advantage of the use of a vertical mixer is the utilization of this in any case necessary stock silo as part of the contacting unit, into which the vertical mixer can also be retrofitted in existing silos. As a result, no additional room for machinery is required for use of this method. Vertical mixers are preferably suitable for silos having a capacity of up to 100 m³, particularly preferably for silos having a capacity in the range from 1 to 100 m³.

For the triboelectric charging to be able to take place very effectively for the entire mixture to be processed, i.e. for as many as possible particles of the preferably fine, e.g. dust-like, chemically conditioned salt mixture, a sufficient residence time in the stock silo has to be adhered to. The residence time necessary for a satisfactory separation result has to be set down as a function of the size of the silo and the fill level of the silo suitable for operation and can be determined by means of simple routine tests. Typical residence times are preferably in the range from 0.1 to 2 hours, particularly preferably in the range from 0.5 to 1 hour.

The degree of triboelectric charging also depends on the degree of fill of the vessel/silo in which the mechanical movement of the salt mixture by means of a vertical mixer occurs. The vessel/silo preferably has a fill level or a fill height of at least 20%, particularly preferably at least 25%, in particular at least 30%, based on the height of the vessel/silo. At these fill levels, the mixing process can take place without difficulty. The salt protective layer necessary for sufficient particle-particle contacts in order to bring about triboelectric charging of the salt mixture, in particular the salt dust, is present.

For this reason, operation is preferably carried out using an appropriate minimum fill level of the vessel when triboelectric charging is to be effected.

The quality of the triboelectric charging of the dust-like salt mixture can be assessed with the aid of the separation result obtained by means of the separation apparatus.

The salt mixtures to be used in the method of the invention or in the apparatus of the invention are typically mixtures of inorganic salts. They are in particular crude potassium salts as setforth in the literature described at the outset.

The crude potassium salts typically contain halite, sylvine and/or kieserite, in particular halite/sylvine or halite/sylvine and kieserite. The method of the invention makes it possible to separate sylvine and/or kieserite from halite in the crude potassium salts, as can be seen from the following examples.

The crude potassium salts which are preferably used in the method of the invention typically contain from 5 to 25% by weight of sylvine and, if present, from 5 to 35% by weight of kieserite, based on the crude potassium salts.

Preferred crude potassium salts contain from 50 to 80% by weight of halite, from 10 to 20% by weight of sylvine and from 10 to 30% by weight of kieserite and up to 10% by weight of further constituents, based on the crude potassium salts whose total amount adds up to 100% by weight.

The salts used are preferably crude salts from potash mines, known as hard salts or sylvinites.

The hard salts have essentially the following contents of the mineral phases:

Sylvine (KCl): 5-25% by weight
Kieserite (MgSO₄×1H₂O): 5-35% by weight
Halite (NaCl): 40-90% by weight
Anhydrite (CaSO₄): about 0.5-2%

Sylvinites have essentially the following contents of mineral phases:

Sylvine (KCl): 5-25% by weight
Halite (NaCl): 75-95% by weight
Anhydrite (CaSO₄): about 0.5-2%

In order to achieve triboelectric charging of the salt mixture, this is typically firstly brought into contact with a chemical conditioning agent. This contacting can, for example when using vaporizable conditioning agents, be carried out by blowing conditioning agents vaporized in a compressed air stream having a suitable temperature into the bed of the fluidized particles of the salt mixture. Such a method is described in EP-A-0 231 441. The chemical conditioning agent described there is salicylic acid. The chemical conditioning can also be carried out in a fluidizing chamber, as described in EP-A-0 231 441.

Further suitable conditioning agents are aromatic C7-15-carboxylic acids and salts thereof, C5-20-fatty alcohols, C2-20-alkanoic acids or C2-20-hydroxycarboxylic acids, for example glycolic acid, cinnamic acid, lactic acid, 2-aminobenzoic acid, Kalcol or ammonium benzoate. For a description, reference may be made to EP-A-2 875 869, page 4, lines 9 to 35. Further suitable conditioning agents such as acetylsalicylic acid, ammonium benzoate and fatty alcohols and also suitable amounts to be used are described in EP-B-1 884 287. This document also contains further information on temperature and relative atmospheric humidity for triboelectric charging and conditioning. The amount of conditioning agent to be used depends on the particle size in the salt mixture. The smaller the particle size and, accordingly, the greater the specific surface area of the salt mixture, the larger the amount of conditioning agent required. The amount of conditioning agent to be used is usually in the ppm range, and for salt mixtures having a particle diameter of not more than 0.1 mm it is preferably from 50 to 300 ppm.

The chemical conditioning agent is particularly advantageously blown into the fluidized bed of the salt mixture a little above the inflow plate and underneath the heating devices located above this, as described in EP-A-0 231 441.

The subsequent triboelectric charging can be carried out at room temperature or elevated temperature. A suitable temperature can be determined by means of routine tests. Triboelectric charging is typically carried out at temperatures in the range from 25 to 120° C., particularly preferably from 25 to 100° C. For a particle size fraction of not more than 0.1 mm, particular preference is given to working in a temperature range from 25 to 50° C.

Furthermore, it is necessary to free the salt mixture of moisture in order to make it more readily triboelectrically chargeable. The relative moisture for the salt mixture is generally in the range from 1 to 40%, particularly preferably from 5 to 40%. In the case of a particle size fraction of not more than 0.1 mm, the relative moisture is particularly preferably from 10 to 40%.

The relative moisture here is based on the relative atmospheric humidity.

The salt mixture which has been triboelectrically charged with the aid of the vertical mixer is separated in a subsequent electric field of an apparatus having, for example, vertically arranged electrodes into a desired material fraction and a residue fraction. For the in-principle procedure, reference may be made to G. Fricke, Kali und Steinsalz, Number 9/1986, pages 287-295. Vertical separators are typically free-fall separators which can have an areal or tubular shape. Suitable separators are also described in the literature cited at the outset.

The invention will be illustrated by the following examples.

### EXAMPLE 1

The following separation results in the conventional electrostatic separation of a specifically chemically conditioned salt mixture (composition: 18.6% of sylvine, 12.9% of kieserite, 1.0% of anhydrite, 62.7% of halite, 2.1% of carnallite, 0.9% of langbeinite, conditioning agent salicylic acid/glycolic acid) having a particle diameter of not more than 0.1 mm were obtained by means of a vertical mixer which can be operated in batch operation, optionally also continuously, (silo volume 1.5 m³), as is described above, at a residence time (ResT) of 60 minutes (3 experimental runs, values rounded):

TABLE 1

| | Sylvine | Sylvine | Kieserite | Kieserite |
|---|---|---|---|---|
| | yields of | content | yield of | content |
| | desired | of | desired | of |
| | material | residue | material | residue |
| Experiment | [eta %] | [%] | [eta %] | [%] |
| 1 | 89 | 3.6 | 85 | 3.5 |
| 2 | 95 | 1.6 | 86 | 3.4 |
| 3 | 86 | 3.5 | 86 | 3.5 |

The data demonstrate the good reproducible separation results for the separation of the mineral phases sylvine and kieserite from the dust-like salt mixture obtained by contacting in a vertical mixer.

Experiment 1 is, by way of example, reported below as mineral phase balance:

### EXAMPLE 2

The following separation results in the conventional electrostatic separation of a specifically chemically conditioned salt mixture (composition: 17.2% of sylvine, 14.9% of kieserite, 1.0% of anhydrite, 61.2% of halite, 2.9% of carnallite, 1.0% of langbeinite; conditioning agent salicylic acid) having a particle diameter of not more than 0.1 mm were obtained by means of a vertical mixer which can be operated in batch operation, optionally also continuously, (silo volume 1.5 m³), as is described above, with additional fluidization by means of a pneumatically operated fluidization plate in the silo as a function of the residence time (ResT):

TABLE 2

| | | Sylvine | Sylvine | | Sylvine | Sylvine |
|---|---|---|---|---|---|---|
| | Resi- | content of | content of | Sylvine | yield of | sepa- |
| | dence | starting | desired | content of | material | ration |
| Exper- | time | material | material | residue | of value | factor |
| iment | [min] | [%] | [%] | [%] | [eta %] | P/N |
| 4 | 60 | 17 | 42 | 1.5 | 95 | 47 |
| 5 | 30 | 20 | 40 | 4.5 | 87 | 14 |
| 6 | 10 | 20 | 33 | 7.8 | 80 | 6 |

It is clear from the data that the mineral phase sylvine is separated off better in the electric field with increasing residence time (ResT).

The experiment at 60 minutes residence time with fluidization is reported by way of example below as mineral phase balance (experiment 4):

### EXAMPLE 3

The following separation results in the conventional electrostatic separation of a specifically chemically conditioned salt mixture (composition: 19.8% of sylvine, 15.0% of kieserite, 1.1% of anhydrite, 59.9% of halite, 1.7% of carnallite, 0.6% of langbeinite; conditioning agent salicylic acid) having a particle diameter of not more than 0.1 mm were obtained by means of a vertical mixer which can be operated in batch operation, optionally also continuously (silo volume 1.5 m³), as is described above, with and without fluidization at a residence time (ResT) of 30 minutes (rounded):

TABLE 3

| | | Sylvine | Sylvine | | Sylvine | Sylvine |
|---|---|---|---|---|---|---|
| | | content of | content of | Sylvine | yield of | P/N |
| | | starting | desired | content of | desired | sepa- |
| Exper- | Fluid- | material | material | residue | material | ration |
| iment | ization | [%] | [%] | [%] | [eta %] | factor |
| 7 | Yes | 20 | 40 | 5 | 87 | 14 |
| 8 | No | 20 | 32 | 10 | 72 | 4 |

The data show the improved separation of the mineral phase sylvine resulting from higher triboelectric charging of the dust-like salt mixture when fluidization is employed in addition to the mixing process of the vertical mixer in the silo.

Experiment 7 at a residence time of 30 minutes with fluidization is reported by way of example below as mineral phase balance:

### EXAMPLE 4 (COMPARISON)

An attempt was made to achieve triboelectric charging of the salt mixture of example 3 using a horizontal mixing screw. A double mixing screw of the DMSA type from Köllemann was used for this purpose.

The desired reproducible separation of the salt mixture was not able to be achieved.

### EXAMPLE 5 (COMPARISON)

The procedure of example 4 was repeated, but the double mixing screw was replaced by a single-shaft flow mixer (model MFKG 0313 from BHS-Sonthofen). A desired electrostatic separation of the salt mixture was likewise not achieved.

The above examples and comparative examples show that a desired electrostatic separation of chemically conditioned salt mixtures was able to be successfully effected by mechanical movement of the salt mixture only with the aid of the vertical mixer described, but not using the horizontal mixers mentioned.

1. A method for the triboelectric charging of a chemically conditioned salt mixture, the method comprising:
mechanically moving the salt mixture in a vessel by at least one vertical mixer.

2. The method as claimed in claim 1, wherein the at least one vertical mixer has a vertically arranged mixing screw which conveys the salt mixture vertically upward from a bottom of the vessel.

3. The method as claimed in claim 2, wherein the vertically arranged mixing screw is arranged at least partly in a mixing tube so that the salt mixture is conveyed vertically upward in the mixing tube and wherein the mixing tube has one or more lateral openings along the mixing tube's course, through which openings the salt mixture exits laterally from the mixing tube.

4. The method as claimed in claim 3, wherein at least one of the one or more lateral openings is arranged within a mixing head, by which the direction of movement of the salt mixture outside the mixing tube is changed to vertically downward.

5. The method as claimed in claim 4, wherein the mixing head is configured as a sleeve having a shape of a frustum of a cone which surrounds the mixing tube and rests against the mixing tube at a top and is open in a downward direction, so that the salt mixture exits vertically in the downward direction from the mixing head outside the mixing tube.

6. The method as claimed in claim 1, wherein the vessel has a shape of a silo having sidewalls tapering conically to the bottom at least in a lower fifth of the height of the silo.

7. The method as claimed in claim 6, wherein the silo has a circular cross section in the center of which the vertical mixer is arranged.

8. The method as claimed in claim 1, wherein at least one apparatus for fluidizing the salt mixture is arranged in the vessel in addition to the at least one vertical mixer.

9. The method as claimed in claim 1, wherein a device for heating the salt mixture is arranged in or on the vessel.

10. The method as claimed in claim 1, wherein the salt mixture has a particle diameter of not more than 1 mm.

11. The method as claimed in claim 1, wherein the salt mixture is a crude potassium salt comprising halite, sylvine, and/or kieserite.

12. The method as claimed in claim 11, wherein the crude potassium salt comprises:
from 40 to 90% by weight of halite,
from 5 to 25% by weight of sylvine,
from 5 to 35% by weight of kieserite, and
up to 50% by weight of further constituents,
based on the crude potassium salt, whose total amount adds up to 100% by weight.

13. A method for electrostatic separation of a salt mixture, comprising:
contacting a salt mixture with a chemical conditioning agent, thus producing a chemically conditioned salt mixture,
subsequently triboelectrically charging the chemically conditioned salt mixture by the method as claimed in claim 1, thus producing a triboelectrically charged salt mixture, and
subsequently electrostatically separating the triboelectrically charged salt mixture.

14. (canceled)

15. (canceled)

16. An apparatus for the triboelectric charging of a chemically conditioned salt mixture by mechanical movement of the salt mixture, said apparatus comprising:
a vessel having at least one vertical mixer arranged therein, and
optionally an apparatus for fluidizing the salt mixture and/or a device for heating the salt mixture in or on the vessel.

17. The method as claimed in claim 8, wherein the at least one apparatus for fluidizing the salt mixture is a pneumatically operated fluidization plate in the vessel in combination with adjoining flow pads at sidewalls of the vessel.

18. The method as claimed in claim 9, wherein the device for heating the salt mixture is a heated exterior wall of the vessel.

19. The method as claimed in claim 10, wherein the salt mixture has a particle diameter of not more than 0.1 mm.

20. The method as claimed in claim 13, wherein the salt mixture is a crude potassium salt.

21. The apparatus as claimed in claim 16, wherein the at least one vertical mixer has a vertically arranged mixing screw which conveys the salt mixture vertically upward from a bottom of the vessel.

22. The apparatus as claimed in claim 21, wherein the vertically arranged mixing screw is arranged at least partly in a mixing tube so that the salt mixture is conveyed vertically upward in the mixing tube and wherein the mixing tube has one or more lateral openings along the mixing tube's course, through which openings the salt mixture exits laterally from the mixing tube.

23. The apparatus as claimed in claim 22, wherein at least one of the one or more lateral openings is arranged within a mixing head, by which the direction of movement of the salt mixture outside the mixing tube is changed to vertically downward.

24. The apparatus as claimed in claim 23, wherein the mixing head is configured as a sleeve having a shape of a frustum of a cone which surrounds the mixing tube and rests against the mixing tube at a top and is open in a downward direction, so that the salt mixture exits vertically in the downward direction from the mixing head outside the mixing tube.

25. The apparatus as claimed in claim 16, wherein the vessel has a shape of a silo having sidewalls tapering conically to the bottom at least in a lower fifth of the height of the silo.

26. The apparatus as claimed in claim 25, wherein the silo has a circular cross section in the center of which the vertical mixer is arranged.
